(19) United States
(12) Patent Application Publication
(10) Pub. No.: US 2003/0112306 A1
(43) Pub. Date: Jun. 19, 2003

(54) System and method for form processing

(76) Inventors: Shell S. Simpson, Boise, ID (US); Ward S. Foster, Boise, ID (US); Kris R. Livingston, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/021,340

(22) Filed: Dec. 13, 2001

(51) Int. Cl. B41J 2/01

(52) U.S. Cl. 347/101

(57) ABSTRACT

The present disclosure relates to a form processing system and method. In one arrangement, the system and method pertain to receiving data to be included in a form to be printed via a network, configuring the received data for printing on a form, and facilitating printing of the form. In another arrangement, the system and method pertain to accessing form imaging data from at least one store via a network, retrieving the form imaging data from the at least one store, and printing the form imaging data along with static form data as a hard copy form.

### FIELD OF THE INVENTION

The present disclosure relates to a system and method that facilitates form processing. More particularly, the disclosure relates to a web-based system and method with which forms can be filled out and, if desired, printed.

### BACKGROUND OF THE INVENTION

Traditionally, forms have been completed by hand. For example, the person that is to complete the form typically receives a preprinted form having a plurality of boxes and/or blanks in which the user can manually write in the information to be provided. More recently, however, form processing applications have been developed for electronically completing forms. With such applications, the user can, for instance, view an electronic representation of a form and enter the pertinent information within data fields of the form.

Although providing the user with the flexibility of easily correcting mistakes made in completing a form and of permitting the user to print multiple copies of the completed form, current form processing applications have their drawbacks. First, these applications tend to be quite expensive because of the effort involved in acquiring, installing, and maintaining software on client machines. This drawback is particularly significant where the user only needs to complete the form once and/or where the form to be completed each year and its official version is likely to change from year to year (e.g., tax forms).

Another drawback of current form processing solutions is that, where the static form data (i.e., the blank form shell) is to be protected, it may be disadvantageous to offer a form processing application for that particular form. Accordingly, the owner or controller of the form may not even offer the form in electronic form.

From the above, it can be appreciated that it would be desirable to have a form processing system and method that avoids one or more of the problems noted above.

### SUMMARY OF THE INVENTION

The present disclosure relates to a form processing system and method. In one arrangement, the system and method pertain to receiving data to be included in a form to be printed via a network, configuring the received data for printing on a form, and facilitating printing of the form. In another arrangement, the system and method pertain to accessing form imaging data from at least one store via a network, retrieving the form imaging data from the at least one store, and printing the form imaging data along with static form data as a hard copy form.

The present disclosure also relates to a printing device. In one arrangement, the printing device comprises hard copy generation hardware, a processing device, and memory including an embedded network server, the server hosting a form processing service with which forms can be created and printed.

### BRIEF DESCRIPTION OF THE DRAWINGS

The invention can be better understood with reference to the following drawings. The components in the drawings are not necessarily to scale, emphasis instead being placed upon clearly illustrating the principles of the present invention.

FIG. 1 is a schematic representation of the general operation of the invention.

FIG. 2 is an example system in which the invention can be implemented.

FIG. 3 is a schematic view of a printing device shown in FIG. 2.

FIG. 4 is a flow diagram that provides an overview of the manner in which the system shown in FIG. 2 can be used to facilitate form processing.

FIGS. 5A and 5B provide a flow diagram of operation of a form processing service of the printing device shown in FIG. 3 in facilitating the filling out of forms and their printing.

FIG. 6 is a schematic view of an example web page that can be used in the method of FIGS. 5A and 5B.

FIG. 7 is a first example distributed web-based imaging system in which the invention can be implemented.

FIG. 8 is a second example distributed web-based imaging system in which the invention can be implemented.

FIGS. 9A and 9B provide a flow diagram illustrating an example of operation of a web-based imaging printing services identified in FIGS. 7 and 8 in providing form printing.

### DETAILED DESCRIPTION

Disclosed is a system and method that facilitates form processing. More specifically, disclosed is a form processing system and method with which forms can be filled out and, if desired, printed as hard copies. Generally speaking, the system and method can be used to access a network-based (e.g., web-based) imaging service that enables a user to identify the imaging data to be used to generate a hard copy form. Once the data has been identified, it can be stored by the service and, if desired, the hard copy form can be generated.

To facilitate description of the inventive system and method, example systems are discussed with reference to the figures. Although these systems are described in detail, it will be appreciated that they are provided for purposes of illustration only and that various modifications are feasible without departing from the inventive concept. After the descriptions of the example systems, examples of operation of the systems are provided to explain the manners in which form generation can be facilitated.

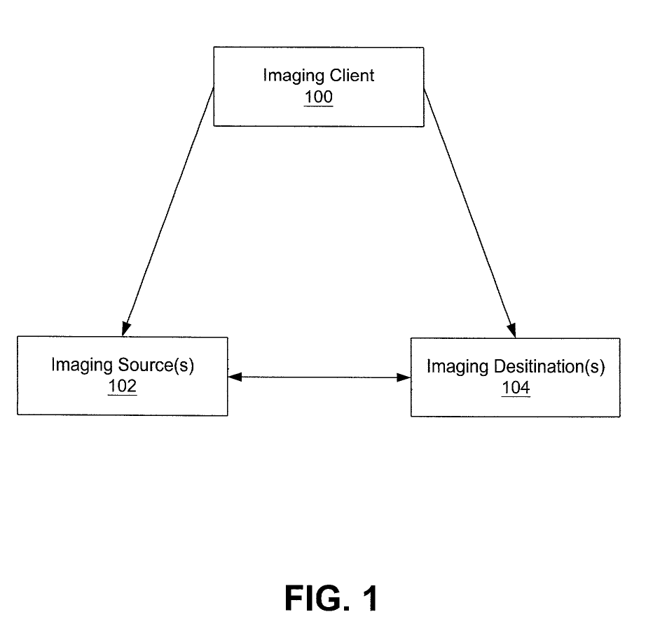

FIG. 1 is a schematic representation of the general operation of the invention. As shown in this figure, an imaging client 100 communicates with one or more imaging sources 102 and one or more imaging destinations 104, which can in some arrangements comprise the same device and/or service. The imaging source(s) 102 represent any of a wide variety of devices/services that can be accessed by the imaging client 100 and used to input data that will be used to create a document, such as a form. Once the imaging data have been input, the imaging client 100 can identify data from the imaging source(s) 102 that are to be used by the imaging destination(s) 104 for printing, as well as the arrangement of the data within the printed document. The image destination(s) 104 can then print the document(s) according to the client's selections.

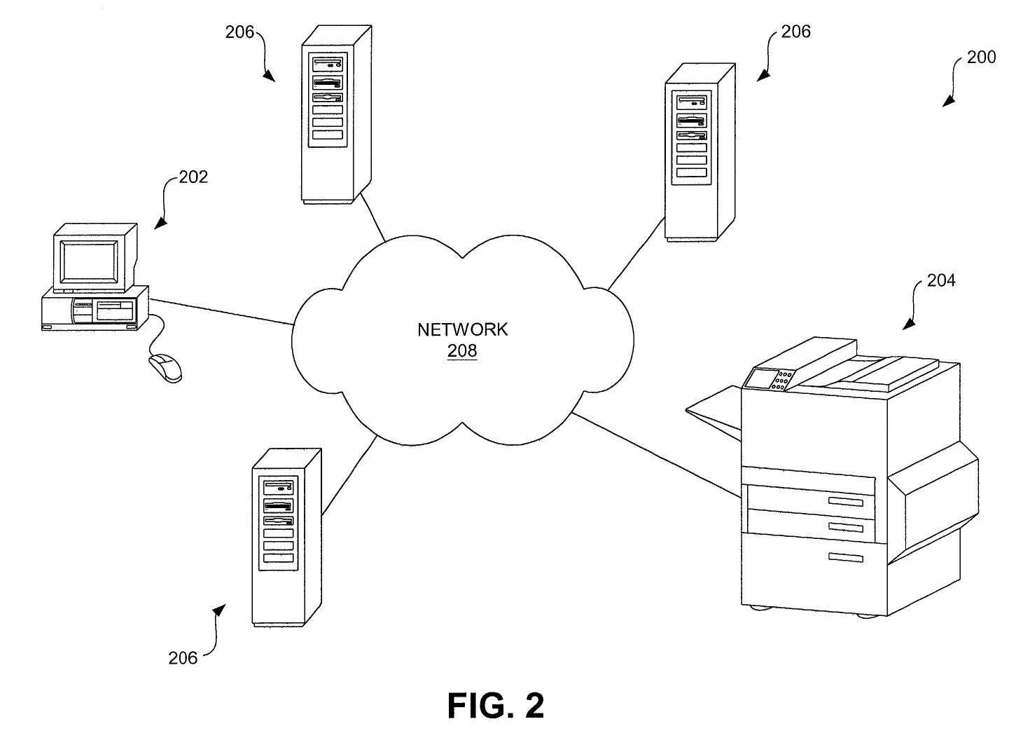

FIG. 2 illustrates a first example system 200 with which the invention can be implemented. As indicated in this figure, the example system 200 generally comprises a computing device 202, a printing device 204, and one or more network servers 206, each of which can be connected to a network 208. As indicated in FIG. 2, the computing device 202 can be arranged as a personal computer (PC). More broadly, however, the computing device 202 can comprise substantially any device that can be used to communicate via the network 208 and, therefore, access and/or be accessed by form processing services made available over the network. By way of example, the computing device 202 can alternatively comprise a notebook computer, Macintosh computer, handheld computer such as a personal digital assistant or mobile telephone, smart card, etc.

The printing device 204 comprises any device that is capable of generating hardcopy forms. Although the term “printing device” is used herein, it is to be understood that the disclosure is not limited to any particular type of device that provides this functionality. Accordingly, the term is intended to include any appliance or printing device (e.g., printer, photocopier, facsimile machine, multifunction peripheral (MFP), etc.) that either inherently provides this functionality or which provides it when a suitable accessory is used in conjunction therewith.

The one or more network servers 206 typically comprise computing devices similar in configuration to the computing device 202, but which normally possess greater resources in terms of processing power, memory, and/or storage space. As will be apparent from the discussions provided below, the network servers 206 are typically used with the Internet and, therefore, may comprise web servers. However, it is noted that the term “Internet” does not necessarily imply the World Wide Web (WWW) in that the Internet supports a wide array of network protocols that go beyond the web. The network 208 normally comprises one or more sub-networks that are communicatively coupled to each other. By way of example, these networks can include one or more local area networks (LANs) and/or wide area networks (WANs) that comprise a set of networks that forms part of the Internet. In addition to the network connections shown in FIG. 2, one or more of the computing device 202 and servers 206 can be directly connected to the printing device 204 (not shown). Direct connection between the computing device 202 and the printing device 204 may be likely where the printing device is used in a home or small office environment in which the user does not have access to a network. Direct connection between a network server 206 and the printing device 204 may be likely where the server functions as a print server controlled by a form processing service.

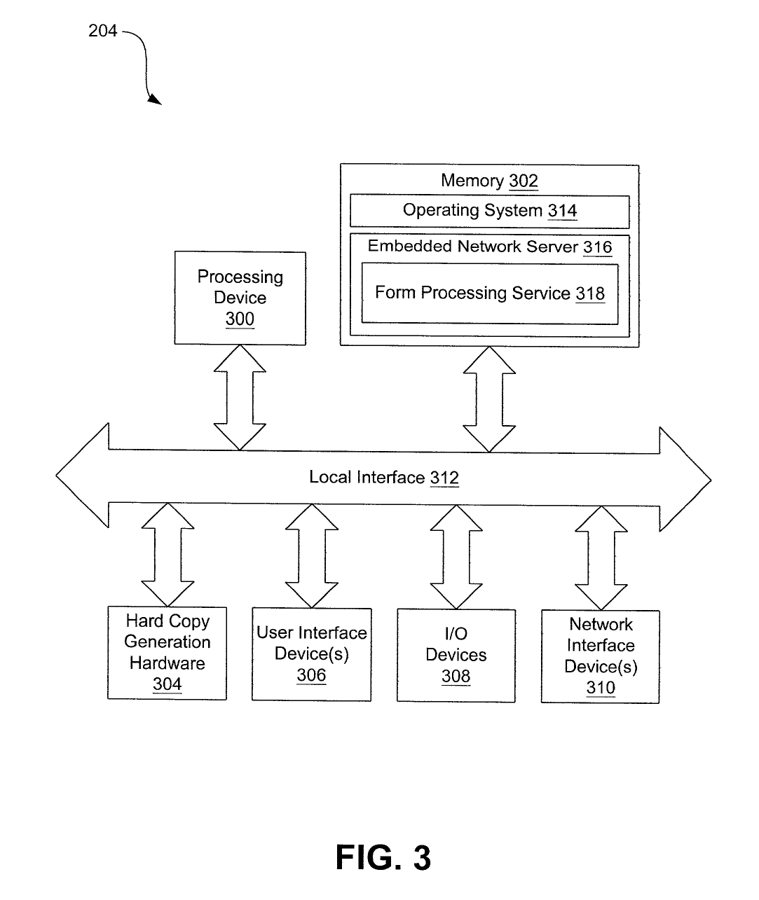

FIG. 3 is a schematic view illustrating an example architecture for the printing device 204 identified in FIG. 2. As indicated in FIG. 3, the printing device 204 can generally comprise a processing device 300, memory 302, hard copy generation hardware 304, one or more user interface devices 306, one or more input/output (I/O) devices 308, and one or more network interface devices 310, each of which is connected to a local interface 312 that normally comprises one or more internal and/or external buses.

The processing device 300 is adapted to execute commands stored in memory 302 and can comprise a general-purpose processor, a microprocessor, one or more application-specific integrated circuits (ASICs), a plurality of suitably configured digital logic gates, and other well known electrical configurations comprised of discrete elements both individually and in various combinations to coordinate the overall operation of the printing device 204. The memory 204 can include any one of a combination of volatile memory elements (e.g., random access memory (RAM, such as DRAM, SRAM, etc.)) and nonvolatile memory elements (e.g., ROM, hard drive, tape, CDROM, etc.).

The hard copy generation hardware 304 comprises the components with which the printing device 204 can generate hard copy documents and, more particularly, with which the device can generate forms. For example, the hard copy generation hardware 304 can comprise a print engine that is possible of many different configurations. The one or more user interface devices 306, where provided, comprise those components with which the user can interact with the printing device 204. By way of example, the user interface devices 306 comprise one or more function keys and/or buttons with which the operation of the device 204 can be controlled, and a display, such as a liquid crystal display (LCD), with which information can be visually communicated to the user and, where the display comprises a touch-sensitive screen, commands can be entered.

With further reference to FIG. 3, the one or more I/O devices 308 are adapted to facilitate communications of the printing device 204 with another device and may therefore include one or more serial, parallel, small computer system interface (SCSI), universal serial bus (USB), IEEE. 1394 (e.g., Firewire™), and/or personal area network (PAN) components. The network interface devices 310 comprise the various components used to transmit and/or receive data over a network 208. By way of example, the network interface devices 310 include a device that can communicate both inputs and outputs, for instance, a modulator/demodulator (e.g., modem), wireless (e.g., radio frequency (RF)) transceiver, a telephonic interface, a bridge, a router, network card, etc.

The memory 204 typically comprises an operating system 314. In addition, where the printing device 204 is adapted to support a service that facilitates form processing, the memory 204 typically includes an embedded network server 316. The operating system 314 controls the execution of other software and/or firmware and provides scheduling, input-output control, file and data management, memory management, and communication control and related services. The embedded network server 316 comprises software and/or firmware that is used to serve information to the network 208. Where the network comprises the Internet (public or private), the embedded network server 316 may function as an embedded web server.

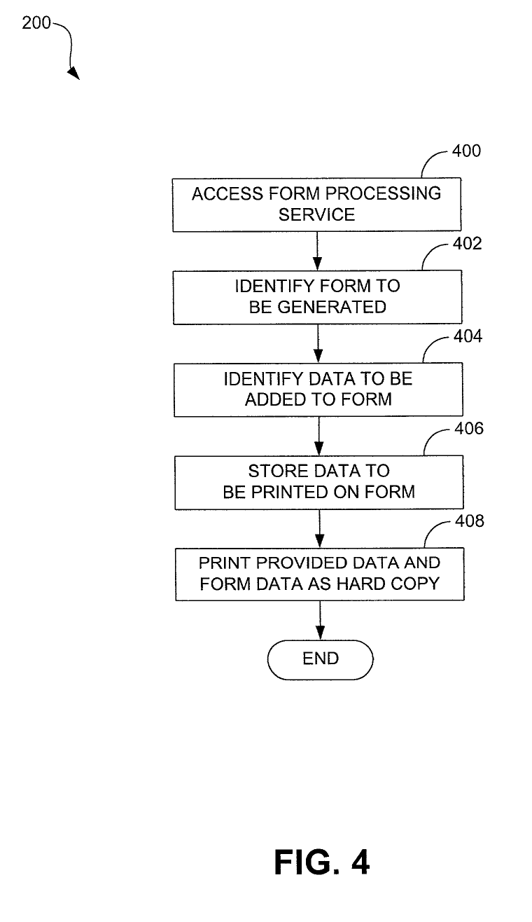

As indicated in FIG. 3, the embedded network server 316, where provided, comprises a form processing service 318 that, as is discussed in greater detail below, can be used to facilitate form processing including the filling out of forms and form printing. The operation of the form processing service 318 when acting in this capacity is described below with reference to FIGS. 4-6. Although the form processing service 318 has been identified as being supported by the printing device 204, persons having ordinary skill in the art will appreciate that this service could, alternatively, be provided by another device, for instance one or more of the network servers 206. As will be apparent from the discussions that follow, however, the location of the form processing service 318 is not critical to the operation of the inventive system and method.

Various software and/or firmware has been described herein. It is to be understood that this software and/or firmware can be stored on any computer-readable medium for use by or in connection with any computer-related system or method. In the context of this document, a computer-readable medium denotes an electronic, magnetic, optical, or other physical device or means that can contain or store a computer program for use by or in connection with a computer-related system or method. These programs can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device.

The computer-readable medium can be, for example but not limited to, an electronic, magnetic, optical, electromagnetic, infrared, or semiconductor system, apparatus, device, or propagation medium. More specific examples (a nonexhaustive list) of the computer-readable medium include an electrical connection having one or more wires, a portable computer diskette, a random access memory (RAM), a read-only memory (ROM), an erasable programmable read-only memory (EPROM, EEPROM, or Flash memory), an optical fiber, and a portable compact disc read-only memory (CDROM). Note that the computer-readable medium can even be paper or another suitable medium upon which a program is printed, as the program can be electronically captured, via for instance optical scanning of the paper or other medium, then compiled, interpreted or otherwise processed in a suitable manner if necessary, and then stored in a computer memory.

An example system 200 having been described above, operation of the system will now be discussed. In the discussions that follow, flow diagrams are provided. It is to be understood that any process steps or blocks in these flow diagrams represent modules, segments, or portions of code that include one or more executable instructions for implementing specific logical functions or steps in the process. It will be appreciated that, although particular example process steps are described, alternative implementations are feasible. Moreover, steps may be executed out of order from that shown or discussed, including substantially concurrently or in reverse order, depending on the functionality involved.

FIG. 4 provides a general overview of the manner in which a user can use the example system 200, or another appropriate system, to facilitate form processing. Beginning with block 400, the form processing service 318 is accessed. Typically, this access is gained via the network 208. For instance, where the form processing service 318 executes on the printing device 204, the user can access the service by directing an appropriate browser to the address (e.g., uniform resource locator (URL)) of the service. After the form processing service 318 has been accessed, the user can identify the type of form that is to be generated, as indicated in block 402. As noted below, the form can comprise substantially any form in which the user can add information. Typically, however, the form comprises one or more data fields in which information can be inserted.

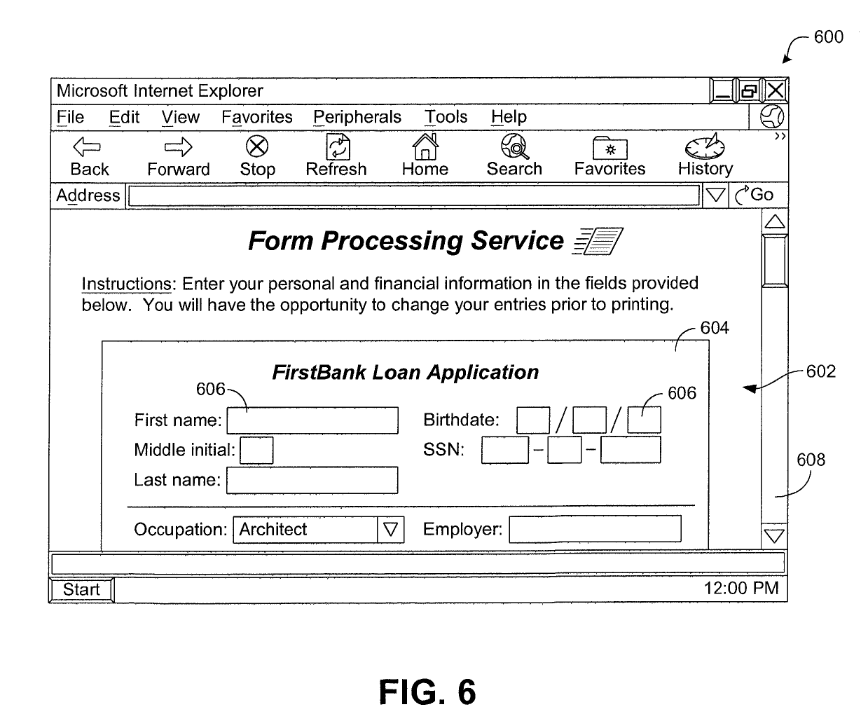

Next, the user can identify the data that is to be added to the form, as indicated in block 404. By way of example, this data can be entered in an electronic representation of the form that is to be printed that is presented to the user on the computing device display. An example of such operation is provided below in FIG. 6. The data that is provided can comprise substantially any data that the user may wish to include on the printed form. Once the data has been entered by the user, the form processing service 318 can store the data, as indicated in block 406. At this point, the user can print the data, along with the form data, i.e., static text and/or graphics that comprise part of the form (e.g., a shell), as indicated in block 408, by issuing a print command to the form processing service 318.

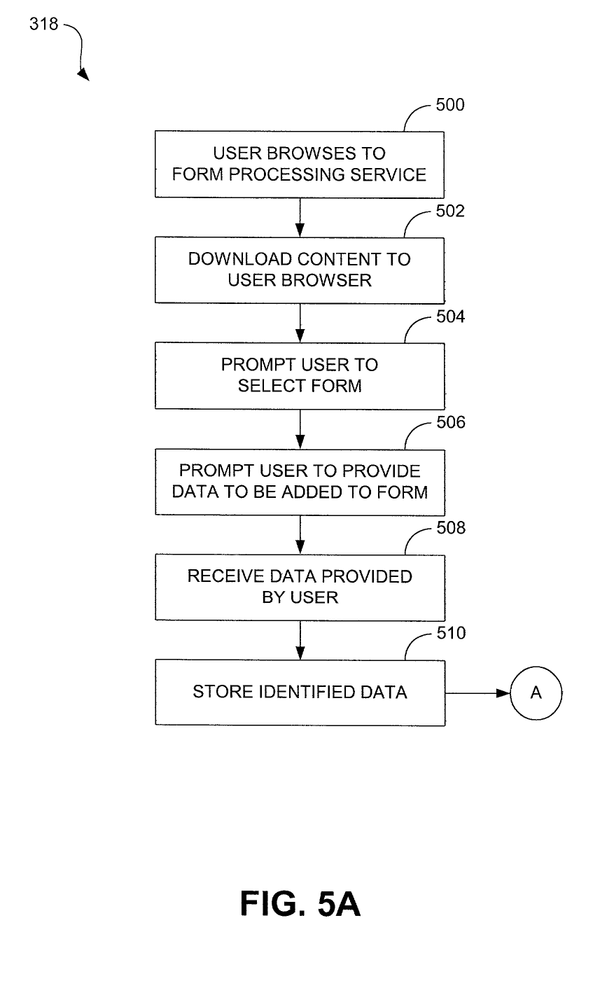

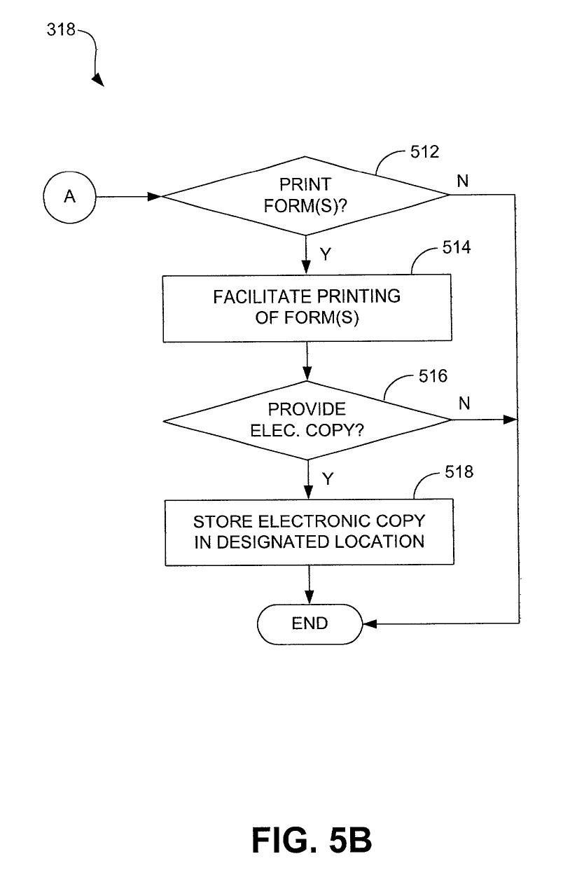

Referring now to FIGS. 5A-5B and FIG. 6, a more detailed example of the operation of the system 200 will be provided. More particularly, an example of operation of the form processing service 318 is provided. Beginning with block 500 of FIG. 5A, the user browses to the form processing service 318 using an appropriate network browser (e.g., web browser) that executes on the user computing device 202. Typically, this service 318 comprises a web site that is accessed via the Internet (and/or Intranet). As noted above, the form processing service 318 can, for example, be executed upon the printing device 204. Once the form processing service 318 is accessed, the service downloads content to the user browser, as indicated in block 502. This content normally includes various text and/or graphics that are displayed to the user to facilitate interfacing between the user and the service 318. This content can, optionally, include one or more applications (e.g., applets) that perform certain functions to aid the form processing service 318 and, thereby, facilitate form generation.

After the form processing service 318 has been accessed, the user can be prompted to select the form he or she would like to produce. The nature of the form can vary greatly depending upon the scenario. For instance, in a business context, the form can comprise an employment application, employee reimbursement form, time sheet, etc. In a personal context, the form may comprise a loan application, tax form, patient form, etc. Irrespective of the nature of the form, however, the user can then be prompted to provide the data that will be added to (i.e., populate) the form.

The form processing service 318 can prompt the user for this data in several different ways. Normally, however, the service 318 prompts the user to manually enter these data. By way of example, the service 318 can present questions to the user and use the answers that have been provided to populate in the form. Alternatively, the user can be provided with a modified (e.g., monitor-friendly) version of the form that includes a plurality of data fields in which the user can enter information. In another variation, the user can be presented with a what-you-see-is-what-you-get (WYSIWYG) representation of the form that will be printed.

Although manual entry of data is one option, it is to be appreciated that the user could, alternatively, provide the data to the form processing service 318 in other ways. For example, the user can facilitate uploading of this data. In such a scenario, the user can identify one or more databases from which the data is to be retrieved. These databases can, for instance, reside on the user computing device 202 (e.g., on a hard disk) and may comprise one or more files associated with a given user application (e.g., spreadsheet). If this option is selected, one or more applications (e.g., applets or signed applets) that were downloaded to the user browser as content can form part of an upload mechanism that is used to perform the upload operation. For instance, the applications can generate a pop-up dialogue box or web page with which the user can provide one or more file names from which the data is to be retrieved. Where the user does not know of the correct filename(s), the applications can, for instance, be used to scan the user's computing device hard disk so that the user may browse through the contents of the hard disk to locate the appropriate file(s).

In another alternative, the user can facilitate retrieval of the data by the form processing service 318 from a remote database. In such a scenario, the user can provide the address (e.g., URL) of the database(s) to be accessed. Again, prompting can be effected through use of a dialogue box or further web page (neither shown). By way of example, the remote database may comprise one or more available database management systems (e.g., Oracle, Cybase, etc.) that the user may presently use to store the data to be printed.

If the user wishes data from a local or remote database to be used to populate the form, provision typically must be made to identify which pieces of information are to be entered into which fields of the form. One way of accomplishing this is to provide a structured query language (SQL) query to the form processing service 318 that identifies which data (e.g., records) are to be placed in which fields. In an alternative arrangement, the data could have been entered in the database in a manner in which each piece of data is tagged in some manner such that, when the data are received by the form processing service 318, their proper locations in the form can be determined.

Irrespective of the manner in which the user is prompted for data, the prompting for the data can, for example, be effected with an interface (e.g., graphical user interface (GUI)) in the form of one or more web pages that are presented to the user with the user browser. FIG. 6 is a schematic representation of an example browser interface 600 in which an example web page 602 is shown that can be used to prompt the user for these data. Although the browser interface 600 is shown as a Windows-based browser interface, it will be appreciated that substantially any browser interface could be used. Therefore, the interface may not appear as indicated in FIG. 6, particularly where the user computing device 202 comprises a handheld computing device such as a PDA or mobile telephone.

As indicated in FIG. 6, the page 602 can present the user with an electronic representation of the form 604 in which the user can manually enter data. For the example of FIG. 6, the form 604 is a loan application form. It will be understood, however, that this form is provided for purposes of illustrating the manner in which the invention can be used and is not intended to limit the scope of the present disclosure. Where provided, the form can include a plurality of data fields 606 in which the user can enter data. As is generally known, the user can access these fields 606 to enter data by “clicking” on a field, by “tabbing” from field to field, or combinations thereof. Where, as indicated in FIG. 6, the entire form 604 does not fit within the view window of the browser interface 600, the user can access the remainder of the form using a scroll bar 608 of the interface.

Returning to FIG. 5A and block 508, the form processing service 318 receives the data provided by the user. At this point, the various data to be printed can be stored by the service 318, as indicated in block 510. Where the service 318 is supported by the printing device 204, (i.e., embedded within the device), the data can be stored within memory 302 (e.g., an internal hard disk) of the device. Where the service 318 is not supported by the printing device 204, or where the device lacks the storage resources to store the data in memory 302, the data can be stored in another appropriate storage location that is accessible by the service.

With reference to FIG. 5B and decision element 512, it can then be determined whether one or more forms are to be printed. If a form is not to be printed, flow for the session is terminated and the user may return to the service 318 at a later time to print the form(s), if desired. If, however, the user does wish to print at least one form, the form processing service 318 facilitates this printing, as indicated in block 514. Typically, this facilitation comprises the merging of the data provided by the user with the form data that comprises part of the form shell.

At this point, it can be determined, in accordance with user preferences, whether an electronic copy of the completed (and printed) form is to be provided to the user, as indicated in decision element 516. If not, flow is terminated and the user can pick up the hard copy form. If, on the other hand, an electronic copy is to be provided, the form processing system 318 can store the copy in a designated location that is accessible via the network 208, as indicated in block 518. By way of example, the form processing service 318 can store an electronic copy in the user's personal imaging repository using the methods described in U.S. patent application Ser. No. ______, entitled “System and Method for Charging for Printing Services Rendered,” by Shell Simpson, Ward Foster, and Kris Livingston and bearing Attorney Docket No. 10008256-1, the disclosure of which is hereby incorporated by reference into the present disclosure.

Operating in the manner described above, the system and method can be used to simplify form processing in that the form data (i.e., the static data portion of the form) need not be provided to the form processing service in that it already holds this information. Accordingly, greater control can be exercised over the form. In addition, because the form processing service stores this form data, the user need not possess any form processing software and/or firmware.

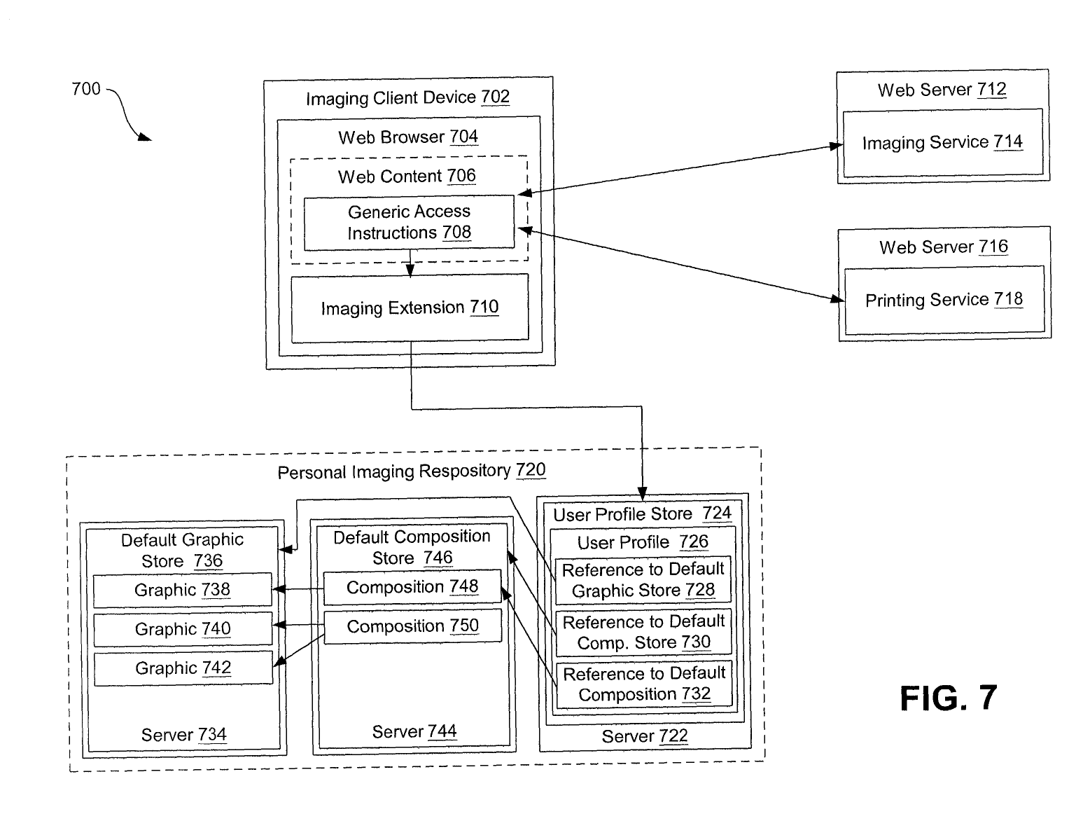

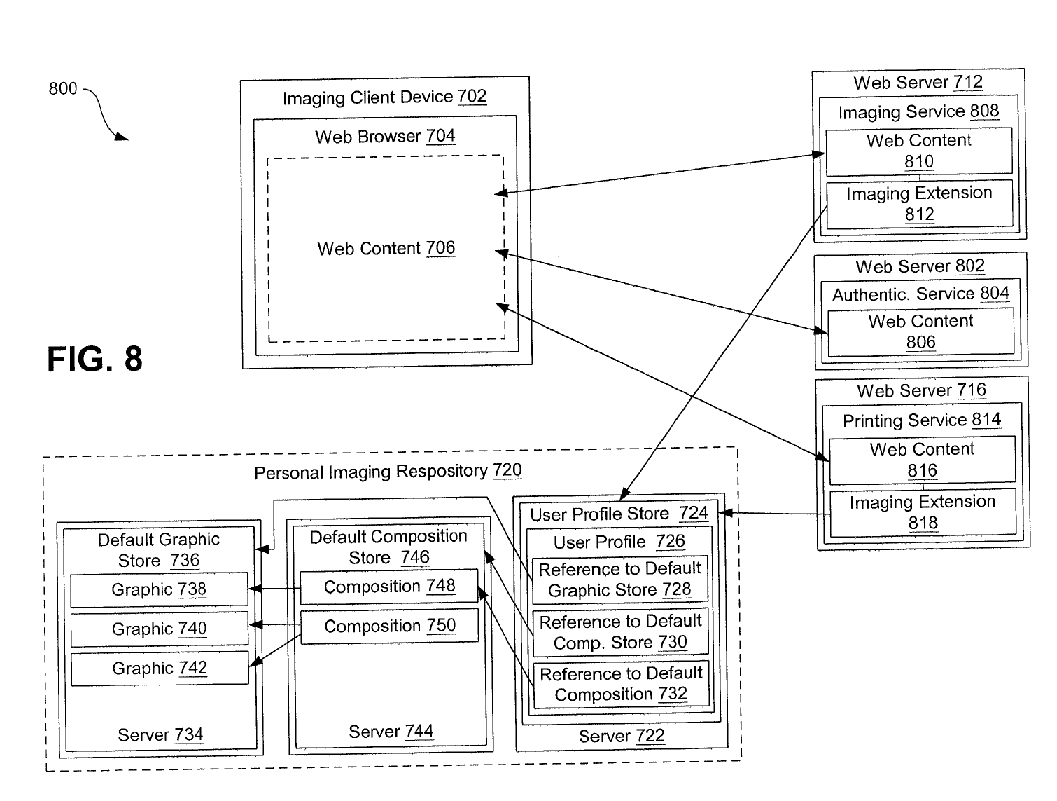

Form processing services can also be provided to users with distributed systems. FIGS. 7 and 8 provide examples of such systems. Beginning with FIG. 7, illustrated is a first example distributed web-based imaging system 700 in which the invention can be implemented. As will be appreciated from the discussion that follows, this system 700 can be described as a client-based implementation in that much of the system functionality is provided by a client device. A similar system is described in detail in U.S. patent application Ser. No. 09/924,058, entitled “A Method, System and Program Product for Multiprofile Operations and Expansive Profile Operation,” by Shell Simpson, Ward Foster, and Kris Livingston and bearing Attorney Docket No. 10007690-1, the disclosure of which is hereby incorporated by reference into the present disclosure. As indicated in FIG. 7, the system 700 includes an imaging client device 702. The imaging client device 702 comprises a web browser 704 that is adapted to access web content 706 derived from web content of an imaging service 714 and a printing service 718 of web servers 712 and 716, respectively. The web content 706 typically comprises text, graphics, and various commands. The commands can comprise one or more sets of executable instructions that are downloaded into the browser 704 to perform a service requested by the user. These instructions can be written in any suitable language including, for instance, HTML, Java™, JavaScript™, C-sharp, or other appropriate language. A variety of different functionalities can be served by the executable instructions. For example, the web content 706 normally includes executable instructions for causing target graphics, i.e. graphics provided by an accessed web site, to be displayed to the user.

In the embodiment shown in FIG. 7, the executable instructions are further used to access a personal imaging repository 720. These instructions typically comprise system-wide generic access instructions 708 that call on methods of an imaging extension 710 to access the personal imaging repository 720 and perform various web imaging operations. These instructions 708 are designated as “generic” because they are independent of the configuration of the user's personal imaging repository 720. As is discussed in greater detail below, the generic access instructions 708 can be used to, for example, add a graphic to a default graphic store 736 of the personal imaging repository 720, or add a new composition to a default composition store 746 of the repository.

As is further indicated in FIG. 7, the imaging extension 710 can form part of the browser 704. Although this arrangement is shown in the figure and described herein, the imaging extension 710 can, alternatively, be provided outside of the browser 704, for instance on a different device. Irrespective of its location, however, the imaging extension 710 is configured to respond to the execution of the generic access instructions 708 by generating/mapping to corresponding imaging client specific commands of the user. The imaging extension 710 typically is implemented as one or more application programming instructions (APIs) that, preferably, act as interfaces in accordance with a system-wide standard.

When executed, the generic access instructions 708 cause imaging extension calls (e.g., API calls) to be issued which, in turn, cause the imaging extension 710 (e.g., APIs) to access to the user's personal imaging repository 720. The web content 706 therefore uses the imaging extension 710 as a gateway to access the user's personal imaging repository 720. Generally speaking, the APIs can comprise sets of methods for establishing a destination for redirecting the browser 704 based on some form of received redirection initiation. In such circumstances, the process normally comprises receiving a redirection initiation to redirect the browser 704, retrieving a direct or indirect reference to a destination, and then causing the browser to browse to that destination. It will be recognized that there are many other ways (both in hardware and software) to implement this same functionality.

In some arrangements, the imaging extension 710 is configured to prevent the web content 706 (i.e., the executable instructions from one or more web services), from arbitrarily accessing the user's personal imaging repository 720. This restricted access can be imposed upon the web content 706 using a variety of methods. For example, an imaging extension API can be configured to only accept references from the web content 706 that were previously provided by the imaging extension 710. In such a scenario, the content 706 cannot arbitrarily supply references when calling the imaging extension API. Therefore, in order to access the user's personal imaging repository 720, the web content 706 must first obtain references using the imaging extension API.

The imaging extension 710 can be used to access one or more user profiles 726 that is/are stored in a user profile store 724 of a server 722 of the personal imaging repository 720. By way of example, the imaging extension 710 can be directed to the user profile 726 with a uniform resource locator (URL), pointer, socket, or other backroom detail. In some embodiments, the same user can have multiple user profiles. This may be particularly advantageous when a firewall (not shown) is used in that different graphic stores and composition stores can be used depending on whether the user is inside or outside of the firewall.

The user profile 726 typically includes references to all or a portion of the personal imaging repository 720 for that user profile. For instance, as shown in FIG. 7, the user profile 726 can include a reference 728 to a default graphic store, a reference 730 to a default composition store, and a reference 732 to a default composition. In use, the user profile 726 functions as a service that uses appropriate methods to create, modify, access, and cancel profiles. Accordingly, the imaging extension 710 maps to the appropriate methods (i.e., makes use of the methods) in the user profile 726 to obtain the reference to various repository items such as the default graphic store 736 and the default composition store 746.

Like the user profile store 724, the default graphic store 736 and default composition store 746 can reside on separate servers 734 and 744. It will be understood, however, that one or more of the stores could reside on a single machine, if desired. As indicated in FIG. 7, the default graphic store 736 is used to store various graphics, such as graphics 738, 740, and 742. These graphics can be stored in substantially any format. For example, these formats can comprise PDF, JPEG, PostScript, TIFF, GIF, BMP, etc. In addition, the default graphic store 736 can include one or more APIs. Therefore, in contrast to merely providing for graphic storage, the graphic store 736 can also provide services used to create, retrieve, and/or manipulate graphics. Furthermore, the default graphic store 736 can communicate with the web content of various web services. For example, the printing service 718 can submit queries to the default graphic store 736 (via the extension 710) about a print job as well as request that one or more graphics be transmitted in a desired arrangement to optimize printing performance.

The default composition store 746 stores various compositions, such as compositions 748 and 750, which can be used to arrange the selected graphics. Like the user profile store 724 and default graphic store 736, the default composition store 746 can also comprise various APIs that can access graphics from the graphic store, manipulate the graphics, etc.

FIG. 8 illustrates a second example distributed web-based imaging system 800 in which the invention can be implemented. As indicated in FIG. 8, the system 800 includes many of the features of the system 700 shown in FIG. 7. Therefore, the system 800 includes an imaging client device 702 that executes a web browser 704 to receive web content 706. The system 800 also includes a personal imaging repository 720 that can, for instance, comprise a user profile store 724, a default graphic store 736, and a default composition store 746. Furthermore, the system 800 includes web servers 712 and 716. Each of these components is generally configured in similar manner as the like-named and numbered features identified in FIG. 7. However, unlike the client-based system 700, the system 800 provides a server-based implementation in which much of the functionality provided by the client device 702 in the system 700 is transferred to another device. By way of example, this other device can comprise a further web server 802, which executes an authentication service 804. As shown in FIG. 8, the authentication service 804 comprises web content 806 (e.g., generated on the fly) that can be downloaded into the user's browser 704.

In addition to the above-noted differences, the servers 712 and 716 are provided with different software in the system 800 to permit alternative modes of operation. By way of example, the web server 712 can execute an imaging service 808, which includes web content 810 and an imaging extension 812. Similarly, the web server 716 can execute a printing service 814, which includes web content 816 and an imaging extension 818. Like the web content of the imaging service 714 and printing service 718 of the system 700, the web content 810 and web content 816 typically comprise text and graphics that can be downloaded into the user's browser 704. Unlike the system 700, however, generic access instructions need not be downloaded into the browser 704 in that the browser does not comprise its own imaging extension. Such an arrangement is advantageous where the client device 702 has limited storage capacity (e.g., for PDAs, mobile telephones). Instead, as identified above, the services 808 and 814 include their own imaging extensions 812 and 818 that can be used to access the user's personal imaging repository 720. By way of example, the content 810 and 816 comprise server-side code including one or more of PHP script, Java™ Servlets, Java™ server pages (JSPs), active server pages (ASPs), etc.

Each of the imaging extensions 812 and 818 typically has a configuration that is similar to that of the imaging extension 710. Therefore, the imaging extensions 812 and 818 can comprise one or more APIs that, when executed, access to the user's personal imaging repository 720. Again, the APIs can comprise sets of methods for establishing a destination for redirecting the browser 704 based on some form of received redirection initiation. The APIs can implement, for instance, a URL, pointer, socket, or other backroom detail to facilitate the redirection.

The manner in which the personal imaging repository 720 is accessed by the services in the system 800 will now be discussed with reference to an example scenario. In this example, the user browses to the imaging service 808 using the web browser 704 of the client device 702. Upon reaching the service 808, web content 810 is executed to generate web pages that are downloaded to the web browser 704 (as content 706). Once this occurs, the browser 704 is redirected by the content 706 to the authentication service 804 that resides on the web server 802. Typically, this is accomplished by the web content 810 by generating a hypertext transfer protocol (HTTP) redirect that, when downloaded to the browser 704, causes the browser to redirect to an address (e.g., URL) identified in the header entry. Web content is then downloaded to the web browser 704 and the user is provided with an opportunity to complete an authentication procedure that identifies both the user's identity and the location of the user's personal imaging repository 720. The authentication procedure can, for example, comprise entry of authentication information, such as a user name and password, that has been registered with the authentication service 804, for example, in a previous session. This information can be entered in a web page generated by the server 802. In an alternative arrangement, the authentication procedure can comprise the reading of a user identification card, which includes storage media (e.g., magnetic strip) that contains the user's authentication information. Persons having ordinary skill in the art will recognize that many other authentication alternatives exist.

Once the authentication procedure is successfully completed by the user, the browser 704 is again redirected, this time back to the imaging service 808. The redirection address (e.g., URL) used to revisit the imaging service 808 contains information that identifies the user and information identifying the user's personal imaging repository 720 (e.g., with a further URL). To avoid continual redirection back and forth, a “cookie” can be stored on the client device 702 that permits the authentication service 804 to validate the user's identity without requiring a further log in. Once this information is possessed by the imaging service 808, the service can, when appropriate, make calls to its imaging extension 812 (e.g., API calls) to command the imaging extension to access the user profile store 724 of the personal imaging repository 720. Through this access, the imaging service 808 can be used by the user to, for instance, select or identify imaging data to be stored as graphics in the default graphic store 736.

When the printing service 814 is accessed, for example through redirection from the imaging service 808 when a “print” button is selected, various content is downloaded to the web browser 706. The printing service 814 can then access the default graphic store 736 and default composition store 746 such that the graphics to be printed can be accessed and their arrangement on the document obtained.

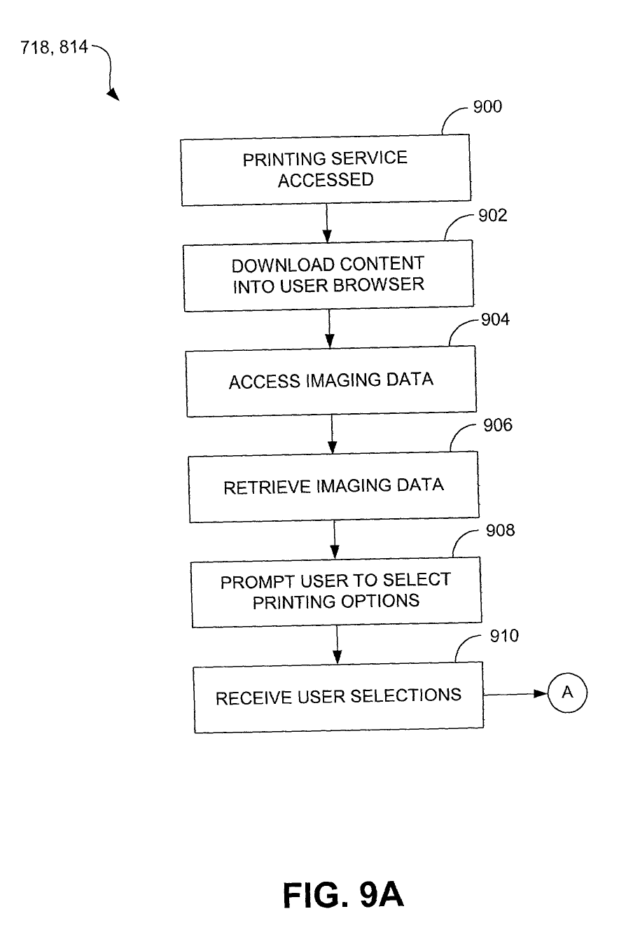

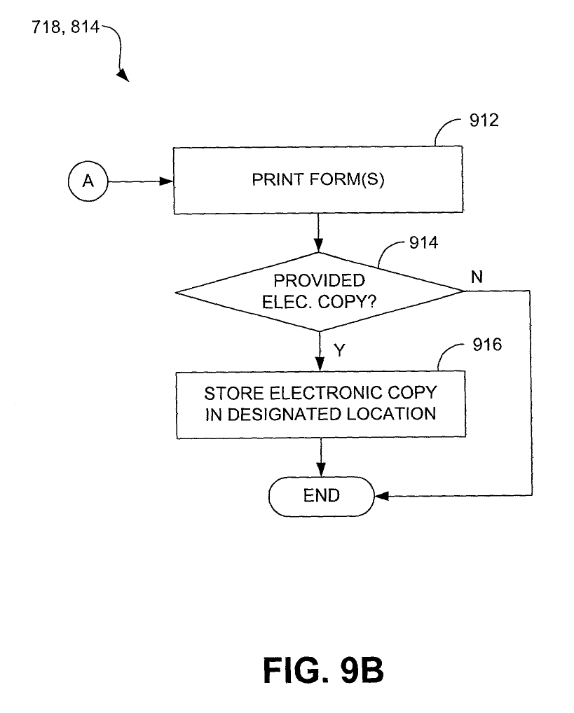

FIGS. 9A and 9B provide an example of operation of a printing service, such as printing service 718 and printing service 814 identified in FIGS. 7 and 8, respectively, in providing form processing services to a user. In this example, it is assumed that the user has created a form, i.e., added data to a form to be printed, at an imaging service (e.g., service 714 or 808) which supports form processing. The flow in the creation of the form is similar to that identified above in relation to FIG. 5A and therefore typically comprises browsing to the imaging service, selecting a form, providing the data to be added to the form, and indicating a desire to print the form.

With reference now to FIG. 9A, the printing service 718, 814 is accessed. As noted above, this access typically is achieved once the user indicates a desire to print a created form. By way of example, the printing service 718, 814 comprises a web site that is accessed via the Internet. Where the imaging service 714, 808 comprises a network-based service, arrival at the printing service 718, 814 can have been effected, for instance, by selecting a “print” button from an imaging service web site.

Once the printing service 718, 814 is accessed, it downloads content 706 into the user's browser 704, as indicated in block 902. This content 706 normally includes various text and/or graphics that are displayed to the user to facilitate interfacing between the user and the service. Where the system is arranged as shown in FIG. 7, the content 706 can also include generic access instructions 708 that call on methods of the imaging extension 710 of the browser 704 so that the user's personal imaging repository 720 can be accessed. Where the system is arranged as shown in FIG. 8, the imaging extension 818 of the printing service can be used to access the personal imaging repository 720. In this latter case, the imaging extension 818 knows the location of the personal imaging repository 720 from information provided to the printing service with, for example, a redirection address (e.g., URL).

Next, the printing service 718, 814 accesses the imaging data (i.e., completed form) that are to be printed, as indicated in block 904. Where the imaging service 714, 808 comprises a network-based service, the printing service 718, 814 can gain access by automatic reference to the user's personal imaging repository 720 using an imaging extension 710 or 818. Assuming the user had just created and/or identified the form(s) using the imaging service 714, 808, the imaging data comprises the default graphics and default composition that were stored by the imaging service.

At this point, the printing service 718, 814 retrieves the imaging data (i.e., form), as indicated in block 906. Once the imaging data have been retrieved, the printing service 718, 814 can prompt the user to select the desired printing options, as indicated in block 908. Typically, this prompting is effected with an interface (e.g., GUI) in the form of one or more web pages that are presented to the user with the browser 704. Once the various selections have been entered by the user, the selections can be received, as indicated in block 910, and the form(s) printed as indicated in block 912 of FIG. 9B.

Next, with reference to decision element 914, it can be determined whether to provide an electronic copy of the printed form(s). If not, flow is terminated. If an electronic copy of the form(s) is to be provided, however, flow continues to block 916 at which the copy is stored, for instance in the user's personal imaging repository 720.

While particular embodiments of the invention have been disclosed in detail in the foregoing description and drawings for purposes of example, it will be understood by those skilled in the art that variations and modifications thereof can be made without departing from the scope of the invention as set forth in the following claims.

What is claimed is:

1. A method for generating a form, comprising the steps of:
receiving data to be included in a form to be printed via a network;
configuring the received data for printing on a form; and
facilitating printing of the form.

2. The method of claim 1, wherein the step of receiving data comprises receiving data with a web-based form processing service hosted by a printing device.

3. The method of claim 1, wherein the step of configuring the received data comprises merging the received data with static form data.

4. The method of claim 1, further comprising storing an electronic copy of the form in a personal imaging repository of a user that initiated printing of the form.

5. A system for generating a form, comprising:
means for receiving data to be included in a form to be printed via a network;
means for configuring the received data for printing on a form; and
means for facilitating printing of the form.

6. The system of claim 5, wherein the means for receiving data comprises
a web-based form processing service hosted by a printing device.

7. The system of claim 5, further comprising means for storing an electronic copy of the form in a personal imaging repository of a user that initiated printing of the form.

8. A printing device, comprising:
hard copy generation hardware;
a processing device; and
memory including an embedded network server, the server hosting a form processing service with which forms can be created and printed.

9. The printing device of claim 8, wherein the form processing service includes logic configured to present a form processing web site to a user.

10. The printing device of claim 8, wherein the form processing service includes logic configured to store a copy of a form in a personal imaging repository of a user that initiated printing of the form.

11. A method for printing a form, comprising the steps of:
accessing form imaging data from at least one store via a network;
retrieving the form imaging data from the at least one store; and
printing the form imaging data along with static form data as a hard copy form.

12. The method of claim 11, wherein the at least one store comprises a graphic store and a composition store.

13. The method of claim 11, wherein the at least one store is associated with an imaging service that is configured to facilitate form completion.

14. The method of claim 13, wherein the imaging source comprises a network-based form processing service.

15. The method of claim 11, wherein the step of accessing form imaging data comprises accessing imaging data through use of an imaging extension.

16. The method of claim 15, wherein the imaging extension comprises part of a user browser.

17. The method of claim 15, wherein the imaging extension comprises part of a network-based printing service.

18. The method of claim 17, wherein the printing service is hosted by a printing device having an embedded server.

19. A system for printing a form, comprising:
means for accessing form imaging data from at least one store via a network;
means for retrieving the form imaging data from the at least one store; and
means for printing the form imaging data along with static form data as a hard copy form.

20. The system of claim 19, wherein the means for accessing form imaging data comprises an imaging extension.

21. The system of claim 20, wherein the imaging extension comprises part of a user browser.

22. The system of claim 20, wherein the imaging extension comprises part of a network-based printing service.

23. The system of claim 22, wherein the printing service is hosted by a printing device having an embedded server.

24. A printing device, comprising:
memory including logic configured to access form imaging data from at least one store via a network, retrieve the form imaging data, and print the form imaging data along with static form data as a hard copy form.

25. The printing device of claim 24, wherein the logic comprises a network-based printing service.

26. The printing device of claim 24, wherein the logic comprises an imaging extension that is configured to access the at least one store.

27. The printing device of claim 24, further comprising an embedded server.
